(19) United States
(12) Patent Application Publication
(10) Pub. No.: US 2012/0169639 A1
(43) Pub. Date: Jul. 5, 2012

(54) ELECTRONIC APPARATUS

(75) Inventors: Ching-Ya TU, Taipei City (TW); Chang-Yuan WU, Taipei City (TW)

(73) Assignee: COMPAL ELECTRONICS, INC., Taipei City (TW)

(21) Appl. No.: 13/342,978

(22) Filed: Jan. 4, 2012

Related U.S. Application Data
(60) Provisional application No. 61/429,759, filed on Jan. 5, 2011.

(51) Int. Cl. G06F 3/041

(52) U.S. Cl. 345/173

(57) ABSTRACT

A touch panel device includes a display module with a touch function and an anti-solar radiation film. The anti-solar radiation film is disposed on a side of the display module and in the touch panel device, so as to prevent solar radiation that passes through the display module to increase an inside temperature of a housing of the touch panel device.

### RELATED APPLICATIONS

This application claims priority to U.S. provisional Application Ser. No. 61/429,759, filed Jan. 5, 2011, which is herein incorporated by reference.

### BACKGROUND

1. Field of Invention

The present invention relates to a touch panel device.

2. Description of Related Art

In recent years, owing to the rapid development of the electronics and information industries, products in these areas are becoming increasingly sophisticated. For current personal computers, in addition to pursuing more rapid and powerful computational ability and offering a wide range of peripheral equipment to meet user needs, compact size for portable computers is also a key area of development.

For example, liquid crystal displays have the advantages of high definition, small size, light weight, low driving voltage, and low power consumption, as well as the ability to be used in a wide range of applications, so they can be widely applied in portable consumer and business electronic products (e.g., televisions, mobile phones, camcorders, notebook computers, and desktop monitors).

A display device using a liquid crystal display module generally encases at least part of the liquid crystal display module. A backlight module, a drive board and the like are attached to the display device, and the display device is placed in a housing for various purposes, such as good appearance and scratch protection. The entire housing is preferably composed of a strong metal or the like in order to reduce the thickness and weight of the display device, and also to protect the relatively fragile liquid crystal panel unit from impact, such as that generated when the liquid crystal panel unit is dropped.

With the advantage of compact size, portable electronic devices with a touch panel function (e.g., smart phones and tablet PCs) are used outdoors more and more frequently. However, after being exposed to solar radiation for a long time, the temperature in the portable electronic devices might increase to an excessive level to thereby cause malfunctioning of the devices.

### SUMMARY

In order to solve the problems of the prior art, the invention provides an improved touch panel device. The touch panel device of the invention utilizes an anti-solar radiation film to substantially seal the opening of a housing of the touch panel device, so as to prevent solar radiation from passing into the housing and thus prevent the temperature in the housing from rising. A touch sensor module and/or a cover lens of the touch panel device can be selectively assembled inside or outside the housing.

According to an embodiment of the invention, a touch panel device includes a display module with a touch function, and an anti-solar radiation film. The anti-solar radiation film is disposed on a side of the display module and in the touch panel device to preventing solar radiation that passes through the display module to increase an inside temperature of a housing of the touch panel device.

In an embodiment of the invention, the housing has an opening and an accommodating space therein. The display module is accommodated in the housing and is assembled to cover on the opening. The anti-solar radiation film substantially seals the opening.

In an embodiment of the invention, the anti-solar radiation film is transparent.

In an embodiment of the invention, the anti-solar radiation film is disposed on the display module through an adhesive.

In an embodiment of the invention, the touch panel device further includes a cover lens disposed on the display module, and the material of the cover lens comprises PMMA or glass.

In an embodiment of the invention, the anti-solar radiation film is disposed between the display module and the cover lens.

In an embodiment of the invention, the anti-solar radiation film is disposed on the surface of the cover lens.

In an embodiment of the invention, the touch panel device further includes a backlight module. The anti-solar radiation film is disposed in the backlight module. The display module is on the backlight module.

In an embodiment of the invention, the display module further includes a touch module to have the touch function. The anti-solar radiation film is disposed on the display module. The display module is the outward surface of the touch panel device, and the touch module is disposed in the display module by using in-cell design.

In an embodiment of the invention, the touch panel device further includes a circuit board in the housing and an electronic element disposed on the circuit board. The increased inside temperature affects a running process of the electronic element and shuts down an operating system of the touch panel device.

It is to be understood that both the foregoing general description and the s following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a sectional view of a touch panel device according to an embodiment of the invention; and

FIG. 2 is a sectional view of a touch panel device according to yet another embodiment of the invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

An improved electronic apparatus is provided. Specifically, a touch panel device of the invention utilizes an anti-solar radiation film disposed on a side of the display module to substantially seal the opening of a housing of the touch panel device, so as to prevent solar radiation from passing into the housing and thus prevent the inside temperature of the housing of the touch panel device from rising, in which the anti-solar radiation film is in the touch panel device. A touch module and/or a cover lens of the touch panel device can be selectively assembled inside or outside the housing. The touch panel device is a tablet computer or a pad computer.

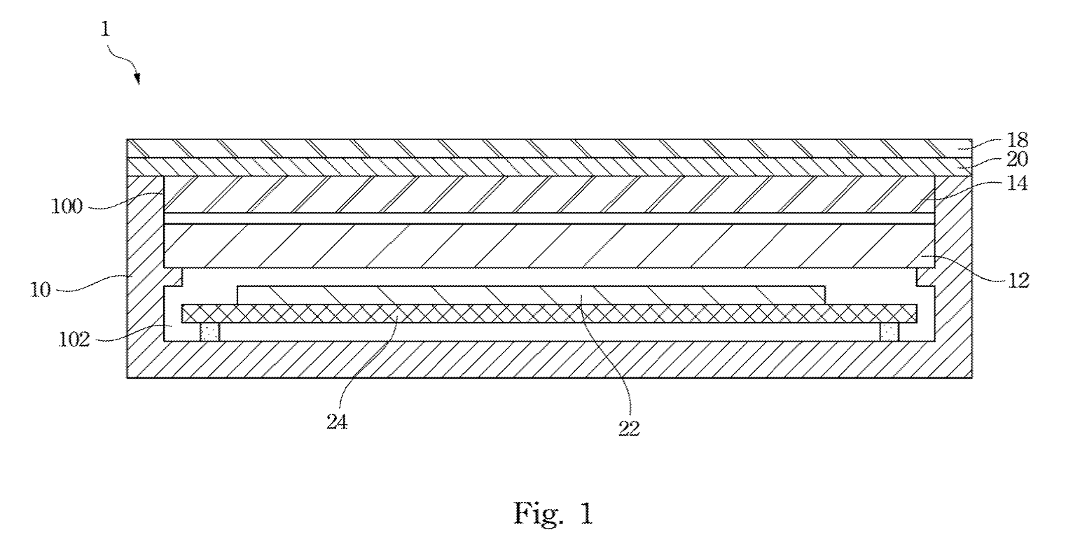

FIG. 1 is a sectional view of a touch panel device 1 according to an embodiment of the invention.

As shown in FIG. 1, the touch panel device 1 according to the embodiment includes a housing 10, a backlight module 12, a display module 14 with touch function, a cover lens 18, an anti-solar radiation film 20, a circuit board 24, and an electronic element 22 disposed on the circuit board 24. The circuit board 24 is a motherboard, and the electronic element 22 is a CPU or VGA chip. The housing 10 of the touch panel device 1 has an opening 100 and an accommodating space 102 therein. The backlight module 12 of the touch panel device 1 is disposed at the bottom of the accommodating space 102 in the housing 10 for emitting planar light. The display module 14 with touch function of the touch panel device 1 is disposed on the backlight module 12 and is accommodated in the accommodating space 102 of the housing 10. The cover lens 18 of the touch panel device 1 is disposed on the display module 14 with touch function. The anti-solar radiation film 20 of the touch panel device 1 is disposed on the display module 14 for preventing solar radiation that passes through the cover lens 18. In an embodiment of the invention, the anti-solar radiation film 20 of the touch panel device 1 is transparent. Accordingly, the planar light emitted by the backlight module 12 of the touch panel device 1 is capable of sequentially passing through the display module 14, the anti-solar radiation film 20, and the cover lens 18, and finally used for displaying images that are visible from outside the touch panel device for users to watch. According to different product designs, when the cover lens 18 is not used in the touch panel device 1, the display module 14 is exposed to become the outward surface of the touch panel device 1, in which the anti-solar radiation film 20 is on the surface of the display module 14. The display module 14 further includes a touch module (not shown) to have touch function, in which the touch module may be designed in the display module 14 by using in-cell design to let the display module 14 have touch function.

As shown in FIG. 1, in the embodiment, the anti-solar radiation film 20 of the touch panel device 1 is adhered on the surface of the display module 16 with an adhesive (not shown), and the adhesive is an optical clear adhesive (OCA). The display module 14 and the cover lens 18 of the touch panel device 1 can be adhered to each other with an optical clear adhesive and can be assembled to cover the opening 100 of the housing 10. Furthermore, the edge of the display module 14 of the touch panel device 1 is supported on the housing 10. Particularly, in the embodiment, the anti-solar radiation film 20 of the touch panel device 1 substantially seals the opening 100 of the housing 10, so as to prevent the solar radiation from passing into the housing 10 of the touch panel device 1 and thus increasing the inside temperature of the touch panel device housing 10 to interrupt the running process of the electronic element 22 in the housing 10, wherein the electronic element 22 is on a circuit board 24 in the housing 10. The increased inside temperature will shut down the operating system of the touch panel device 1.

In an embodiment of the invention, the material of the cover lens 18 of the touch panel device 1 includes, but is not limited to including, PMMA (poly(methyl methacrylate)) or glass.

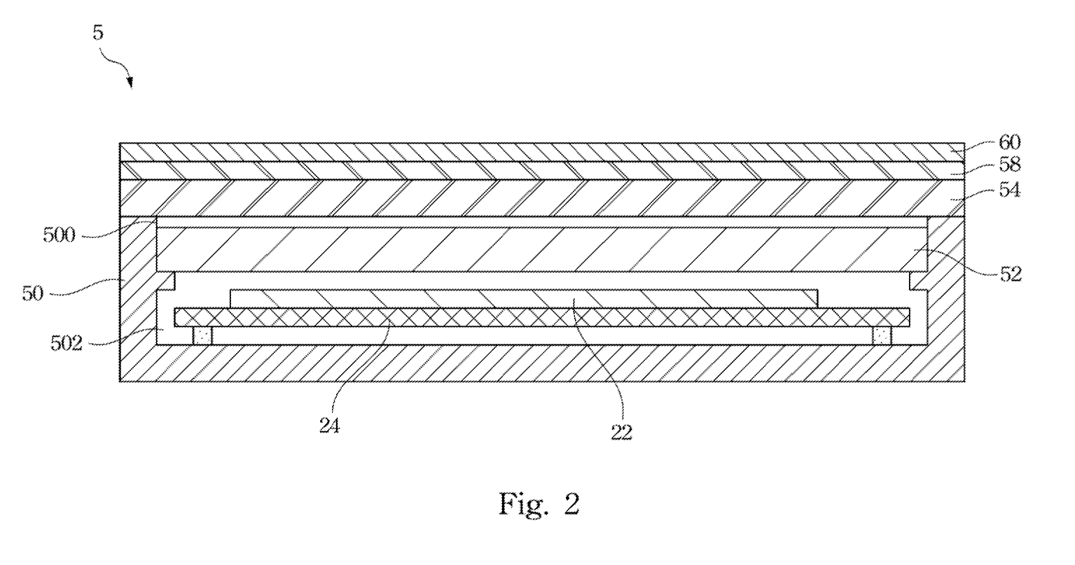

FIG. 2A is a sectional view of a touch panel device 5 according to another embodiment of the invention.

As shown in FIG. 2A, the touch panel device 5 according to the embodiment includes a housing 50, a backlight module 52, a display module 54 with touch function, a cover lens 58, and an anti-solar radiation film 60. The housing 50 of the touch panel device 5 has an opening 500 and an accommodating space 502 therein. The backlight module 52 of the touch panel device 5 is disposed at the bottom of the accommodating space 502 in the housing 50 for emitting planar light. The display module 54 of the touch panel device 5 is disposed on the backlight module 52 and is accommodated in the accommodating space 502 of the housing 50. The cover lens 58 of the touch panel device 5 is disposed on the display module 54 and is accommodated in the accommodating space 502 of the housing 50. In the embodiment, the display module 54 of the touch panel device 5 and the cover lens 58 are adhered to each other with an optical clear adhesive. The anti-solar radiation film 60 of the touch panel device 5 is disposed on the surface of the cover lens 58 for preventing solar radiation from passing into the cover lens 58. In an embodiment of the invention, the anti-solar radiation film 60 of the touch panel device 5 is transparent. Accordingly, the planar light emitted by the backlight module 52 of the touch panel device 5 is capable of sequentially passing through the display module 54, the cover lens 58, and the anti-solar radiation film 60, and finally used for displaying images that are visible from outside the touch panel device for users to watch. The display module 54 further includes a touch module (not shown) to have touch function, in which the touch module may be designed in the display module 54 by using in-cell design to let the display module 54 have touch function.

As shown in FIG. 2A, in the embodiment, the anti-solar radiation film 60 of the touch panel device 5 is adhered on the cover lens 58 with an optical clear adhesive. Particularly, in the embodiment, the anti-solar radiation film 60 of the touch panel device 5 substantially seals the opening 500 of the housing 50, so as to prevent the solar radiation from passing into the housing 50 of the touch panel device 5 and thus increasing the inside temperature of the housing 50 of the touch panel device 5 to interrupt the running process of the electronic element 62 in the housing 50, in which the electronic element 62 is on a circuit board 64 in the housing 50. The increased inside temperature will shut down the operating system of the touch panel device 5.

In an embodiment of the invention, the material of the cover lens 58 of the touch panel device 5 includes, but is not limited to including, PMMA or glass.

In an embodiment of the present invention, the anti-solar radiation film can be disposed in the backlight module (not shown in figures) to decrease the affection of the solar radiation that increases the inside temperature of the housing of the touch panel device to interrupt the running process of the electronic element in the housing, in which the electronic element is on a circuit board in the housing. The increased inside temperature will shut down the operating system of the touch panel device.

According to the foregoing recitations of the embodiments of the invention, it can be seen that the touch panel device of the invention utilizes an anti-solar radiation film to substantially seal the opening of the housing of the touch panel device, so as to prevent solar radiation from passing into the housing and thus prevent the inside temperature of the housing of the touch panel device from rising. A display module and/or a cover lens of the touch panel device can be selectively assembled inside or outside the housing.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A touch panel device comprising:
a display module with a touch function; and
an anti-solar radiation film disposed on a side of the display module and in the touch panel device to prevent solar radiation that passes through the display module to increase an inside temperature of a housing of the touch panel device.

2. The touch panel device of claim 1, wherein the housing having an opening and an accommodating space therein, wherein the display module is accommodated in the housing and is assembled to cover the opening, and the anti-solar radiation film substantially seals the opening.

3. The touch panel device of claim 1, wherein the anti-solar radiation film is transparent.

4. The touch panel device of claim 1, wherein the anti-solar radiation film is disposed on the display module through an adhesive.

5. The touch panel device of claim 1, wherein the touch panel device further comprises a cover lens disposed on the display module; and the material of the cover lens comprises PMMA or glass.

6. The touch panel device of claim 5, wherein the anti-solar radiation film is disposed between the display module and the cover lens.

7. The touch panel device of claim 5, wherein the anti-solar radiation film is disposed on the surface of the cover lens.

8. The touch panel device of claim 1, wherein the touch panel device further comprises a backlight module, the anti-solar radiation film is disposed in the backlight module, and the display module is on the backlight module.

9. The touch panel device of claim 1, wherein the display module further comprises a touch module to have the touch function, the anti-solar radiation film is disposed on the display module, and the display module is the outward surface of the touch panel device and the touch module is disposed in the display module by using in-cell design.

10. The touch panel device of claim 1, wherein the touch panel device further comprises a circuit board in the housing and an electronic element disposed on the circuit board, and the increased inside temperature affects a running process of the electronic element and shuts down an operating system of the touch panel device.
